(19) United States
(12) Patent Application Publication
(10) Pub. No.: US 2024/0421891 A1
(43) Pub. Date: Dec. 19, 2024

(54) RECEIVE BEAM SELECTION FROM RESERVATION INFORMATION

(71) Applicant: QUALCOMM Incorporated, San Diego, CA (US)

(72) Inventors: Chih-Hao LIU, San Diego, CA (US); Jing SUN, San Diego, CA (US); Xiaoxia ZHANG, San Diego, CA (US); Giovanni CHISCI, San Diego, CA (US)

(21) Appl. No.: 18/335,774

(22) Filed: Jun. 15, 2023

(51) Int. Cl. H04B 7/08; H04B 7/06; H04W 72/044

(52) U.S. Cl. CPC H04B 7/088; H04B 7/0695; H04W 72/046

(57) ABSTRACT

Various aspects of the present disclosure generally relate to wireless communication. In some aspects, a first user equipment (UE) may receive, from a second UE, first reservation information that indicates a transmit beam that is reserved for communications from the second UE. The first UE may select a receive beam that is paired with the transmit beam. Numerous other aspects are described.

### FIELD OF THE DISCLOSURE

Aspects of the present disclosure generally relate to wireless communication and to techniques and apparatuses for receiving beam selection from reservation information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include receiving, from a second UE, first reservation information that indicates a transmit beam that is reserved for communications from the second UE. The method may include selecting a receive beam that is paired with the transmit beam.

Some aspects described herein relate to a method of wireless communication performed by a first UE. The method may include receiving, from a second UE, first reservation information that indicates a transmit beam that is reserved for communications from the second UE. The method may include transmitting, to a third UE, second reservation information that indicates that the third UE is to not use a beam resource that is associated with a receive beam that is paired with the transmit beam.

Some aspects described herein relate to a first UE for wireless communication. The first UE may include one or more memories and one or more processors coupled to the one or more memories. The one or more processors may be individually or collectively configured to cause the first UE to receive, from a second UE, first reservation information that indicates a transmit beam that is reserved for communications from the second UE. The one or more processors may be individually or collectively configured to cause the first UE to select a receive beam that is paired with the transmit beam.

Some aspects described herein relate to a first UE for wireless communication. The first UE may include one or more memories and one or more processors coupled to the one or more memories. The one or more processors may be individually or collectively configured to cause the first UE to receive, from a second UE, first reservation information that indicates a transmit beam that is reserved for communications from the second UE. The one or more processors may be individually or collectively configured to cause the first UE to transmit, to a third UE, second reservation information that indicates that the third UE is to not use a beam resource that is associated with a receive beam that is paired with the transmit beam.

Some aspects described herein relate to a non-transitory computer-readable medium that stores a set of instructions for wireless communication by a first UE. The set of instructions, when executed by one or more processors of the first UE, may cause the first UE to receive, from a second UE, first reservation information that indicates a transmit beam that is reserved for communications from the second UE. The set of instructions, when executed by one or more processors of the first UE, may cause the first UE to select a receive beam that is paired with the transmit beam.

Some aspects described herein relate to a non-transitory computer-readable medium that stores a set of instructions for wireless communication by a first UE. The set of instructions, when executed by one or more processors of the first UE, may cause the first UE to receive, from a second UE, first reservation information that indicates a transmit beam that is reserved for communications from the second UE. The set of instructions, when executed by one or more processors of the first UE, may cause the first UE to transmit, to a third UE, second reservation information that indicates that the third UE is to not use a beam resource that is associated with a receive beam that is paired with the transmit beam.

Some aspects described herein relate to a first apparatus for wireless communication. The first apparatus may include means for receiving, from a second apparatus, first reservation information that indicates a transmit beam that is reserved for communications from the second apparatus. The first apparatus may include selecting a receive beam that is paired with the transmit beam.

Some aspects described herein relate to a first apparatus for wireless communication. The first apparatus may include means for receiving, from a second apparatus, first reservation information that indicates a transmit beam that is reserved for communications from the second apparatus. The first apparatus may include transmitting, to a third apparatus, second reservation information that indicates that the third apparatus is to not use a beam resource that is associated with a receive beam that is paired with the transmit beam.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of selecting sidelink resources, in accordance with the present disclosure.

FIG. 6 is a diagram illustrating an example of beam reservations, in accordance with the present disclosure.

FIG. 7 is a diagram illustrating an example of inter-UE coordination (IUC) information, in accordance with the present disclosure.

FIG. 8 is a diagram illustrating an example of IUC information, in accordance with the present disclosure.

FIG. 9 is a diagram illustrating examples of beam reservations, in accordance with the present disclosure.

FIG. 10 is a diagram illustrating an example of beam selection, in accordance with the present disclosure.

FIG. 11 is a diagram illustrating an example of beam selection, in accordance with the present disclosure.

FIG. 12 is a diagram illustrating an example of indicating non-preferred resources, in accordance with the present disclosure.

FIG. 13 is a diagram illustrating an example of indicating non-preferred resources, in accordance with the present disclosure.

FIG. 14 is a diagram illustrating an example process performed, for example, by a UE, in accordance with the present disclosure.

FIG. 15 is a diagram illustrating an example process performed, for example, by a UE, in accordance with the present disclosure.

FIG. 16 is a diagram of an example apparatus for wireless communication, in accordance with the present disclosure.

### DETAILED DESCRIPTION

A first user equipment (UE) may communicate with a second UE via a sidelink. The first UE may sense the sidelink channel in a sensing window to determine which sidelink resources (e.g., subcarriers, subchannels) are available for transmission to the second UE. The first UE may reserve a sidelink resource for transmission to the second UE, but it is likely that other links (e.g., with a third UE) may potentially interfere with the reserved reception by the second UE. Such interference may degrade communications, which increases latency and wastes signaling resources.

According to various aspects described herein, to avoid inter-link interference to the second UE from the third UE, the second UE may reserve the receive beam that is associated with the reserved transmit beam signaled by the first UE and indicate the receive beam in reservation information to a third UE. The third UE may receive the reservation information and select a transmit beam that is not paired with the receive beam selected by the second UE. By indicating, to other UEs, a receive beam paired with a reserved transmit beam, the second UE may avoid or mitigate any interference caused by a transmission from the third UE. This improves reception of the communications. As a result of improved communications, the second UE reduces latency and conserves signaling resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

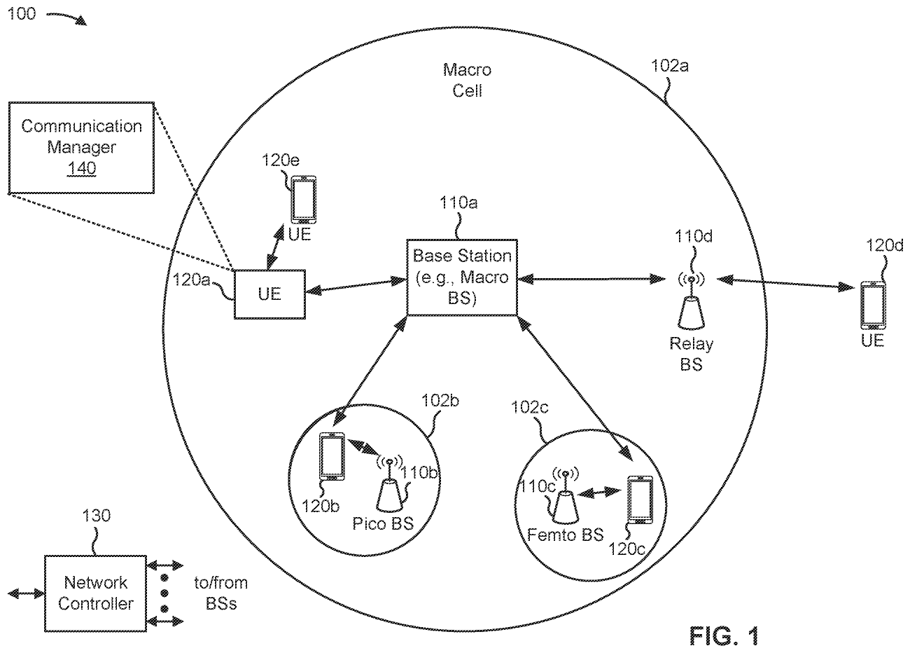

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range (FR) designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., a UE 120) may include a communication manager 140. As described in more detail elsewhere herein, the communication manager 140 may receive, from a second UE, first reservation information that indicates a transmit beam that is reserved for communications from the second UE. The communication manager 140 may select a receive beam that is paired with the transmit beam. Additionally, or alternatively, the communication manager 140 may perform one or more other operations described herein.

In some aspects, a first UE (e.g., a UE 120) may include a communication manager 140. As described in more detail elsewhere herein, the communication manager 140 may receive, from a second UE, first reservation information that indicates a transmit beam that is reserved for communications from the second UE. The communication manager 140 may transmit, to a third UE, second reservation information that indicates that the third UE is to not use a beam resource that is associated with a receive beam that is paired with the transmit beam. Additionally, or alternatively, the communication manager 140 may perform one or more other operations described herein.

As indicated above, FIG. 1 is provided as an example. Other examples may differ from what is described with regard to FIG. 1.

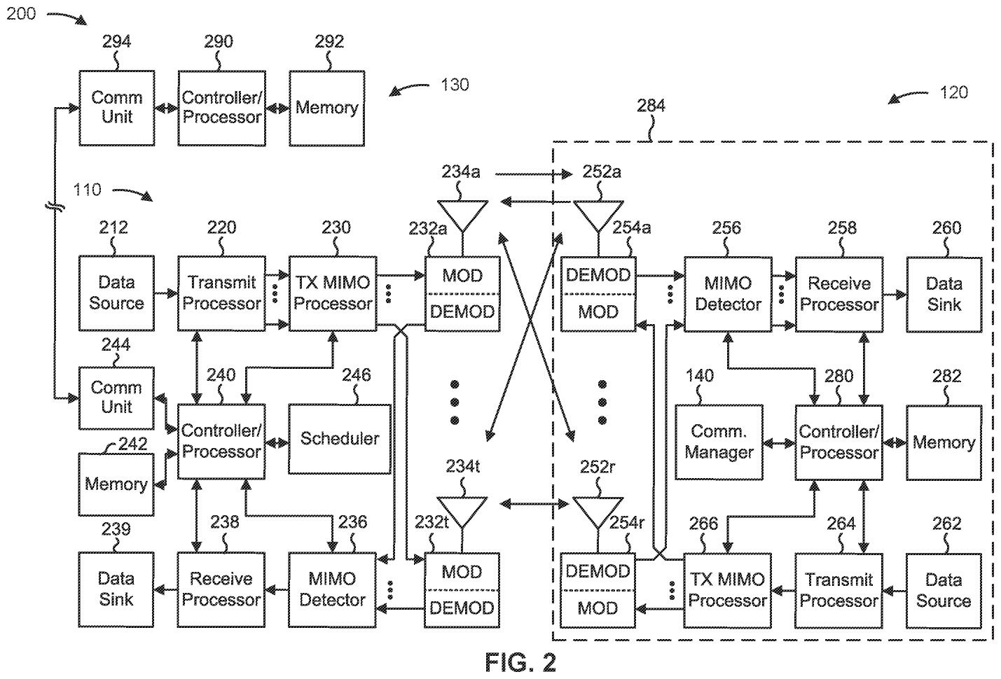

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

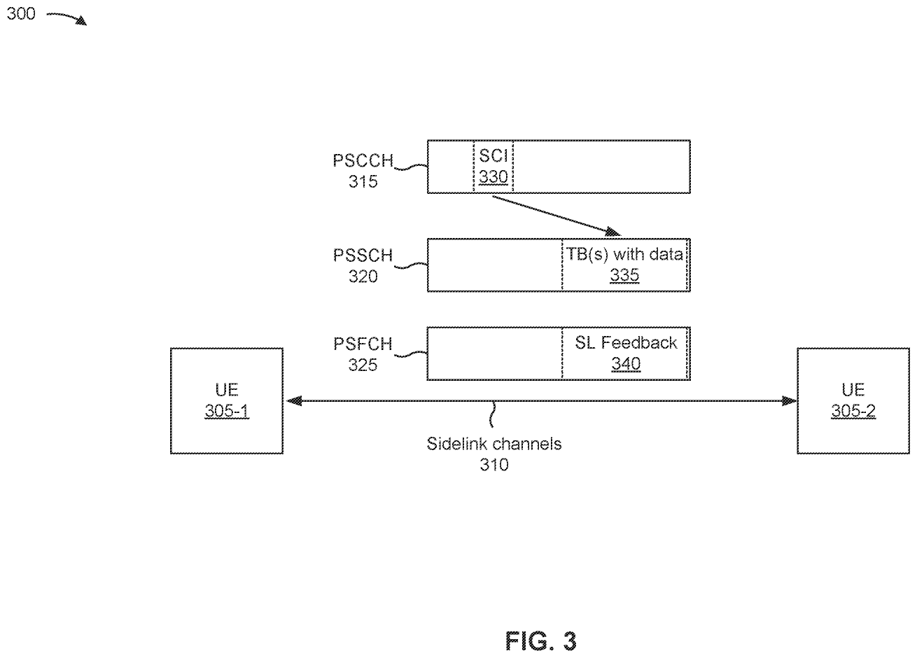

On the uplink, at the UE 120, a transmit processor 264 may receive and process data from a data source 262 and control information (e.g., for reports that include RSRP. RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM) and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-16).

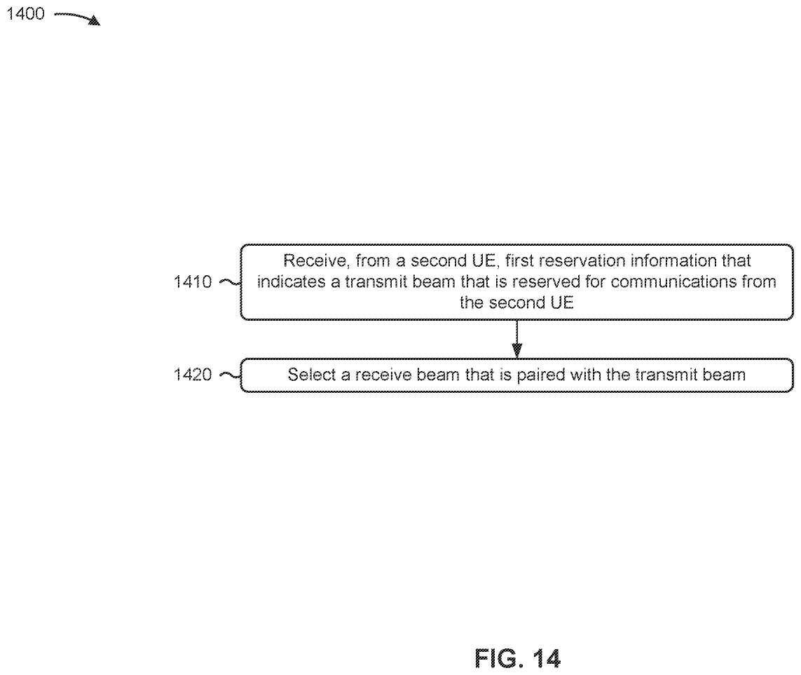

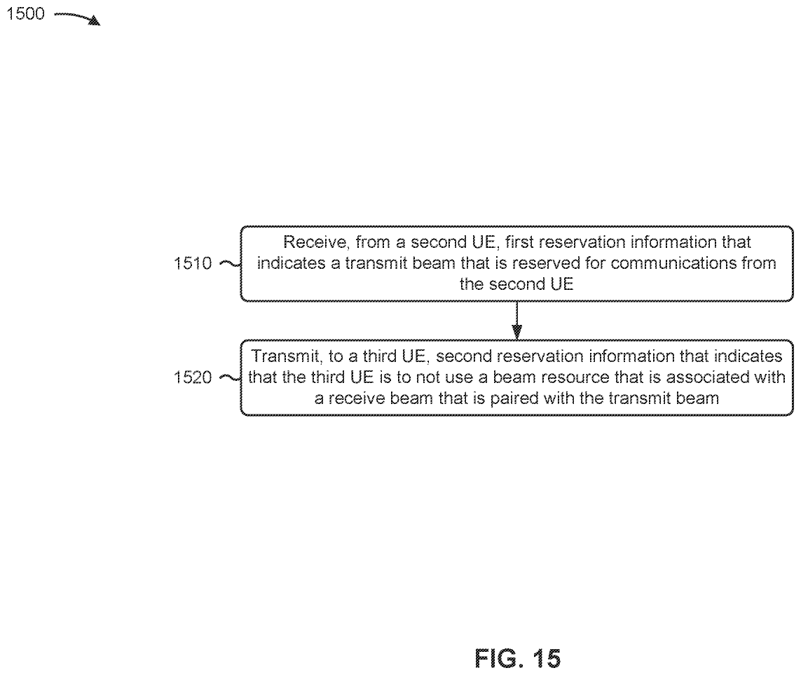

The controller/processor 240 of the network node 110, the controller/processor 280 of the UE 120, and/or any other component(s) of FIG. 2 may perform one or more techniques associated with receiving reservation information for sidelink communications, as described in more detail elsewhere herein. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a first UE (e.g., a UE 120) includes means for receiving, from a second UE, first reservation information that indicates a transmit beam that is reserved for communications from the second UE; and/or means for selecting a receive beam that is paired with the transmit beam. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first UE (e.g., a UE 120) includes means for receiving, from a second UE, first reservation information that indicates a transmit beam that is reserved for communications from the second UE; and/or means for transmitting, to a third UE, second reservation information that indicates that the third UE is to not use a beam resource that is associated with a receive beam that is paired with the transmit beam. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

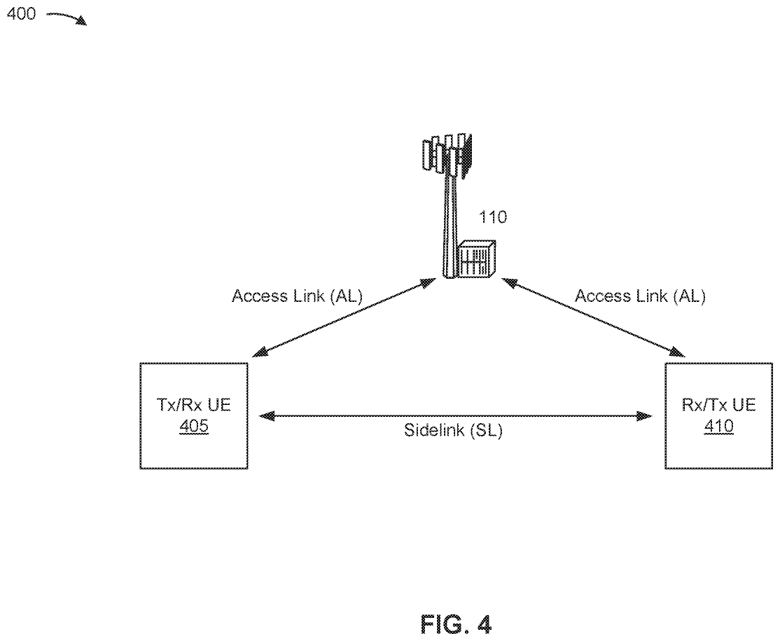

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

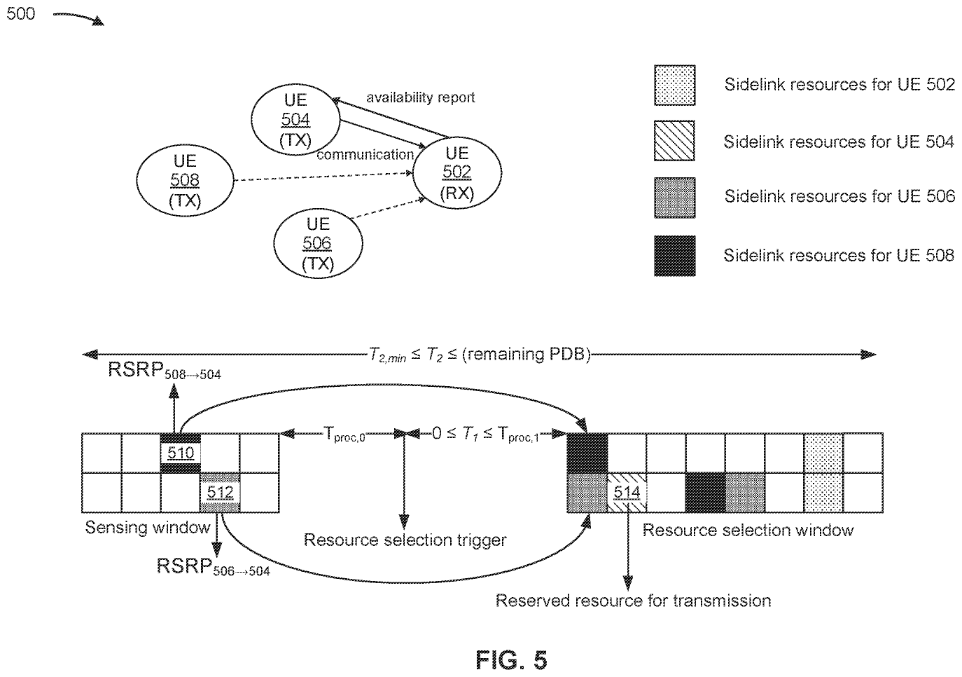

FIG. 5 is a diagram illustrating an example 500 of selecting sidelink resources, in accordance with the present disclosure. Example 500 shows a UE 502 (e.g., a UE 120) that may receive communications on a sidelink channel from other UEs, such as UE 504, UE 506, and/or UE 508.

As described in connection with FIG. 5. UE 504 is a transmitting UE that is transmitting communications to UE 502, which is a receiving UE. UE 504 may use a report from UE 502, which may act as a reporting UE that reports available sidelink resources, preferred sidelink resources, non-preferred sidelink resources, or sidelink resource conflicts. Example 500 shows an availability report from UE 502 to UE 504 and a communication from UE 504 to UE 502.

If UE 504 is to transmit a communication to UE 502, UE 504 may sense the sidelink channel in a sensing window to determine which sidelink resources (e.g., subcarriers, subchannels) are available. UE 504 may use a listen-before-talk (LBT) procedure to sense the channel. The LBT procedure maybe a type 1 LBT procedure, where UE 504 listens for multiple slots (e.g., 9 milliseconds (ms)) and uses a counter. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 504 may measure DMRSs on a PSCCH or a PSSCH, according to a configuration.

For example, UE 504 may prepare to transmit a communication to UE 502. UE 504 may have already sensed previous sidelink resources and successfully decoded SCI from UE 506 and UE 508. UE 504 may try to reserve sidelink resources, and thus may check the availability of the future sidelink resources reserved by UE 506 and UE 508 by sensing the sidelink channel in the sensing window. UE 504 may measure an RSRP of a signal from UE 508 in sidelink resource 510, and an RSRP of a signal from UE 506 in sidelink resource 512. If an observed RSRP (RSRP projection) satisfies the RSRP threshold (e.g., is lower than a maximum RSRP), the corresponding sidelink resource may be available for reservations by UE 504. UE 504 may reserve the sidelink resource (which may be a random selection from available resources). For example, UE 504 may select and reserve sidelink resource 514 for transmission. This may be in a time slot after which UE 506 and UE 508 had used sidelink resources, and UE 504 may have sensed these sidelink resources earlier. UE 504 may select and reserve sidelink resources only upon reaching a threshold level (e.g., 20%, 30%, or 50% availability). UE 504 may increase or decrease the RSRP threshold as necessary to arrive at the threshold level. UE 504 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

As indicated above, FIG. 5 is provided as an example. Other examples may differ from what is described with regard to FIG. 5.

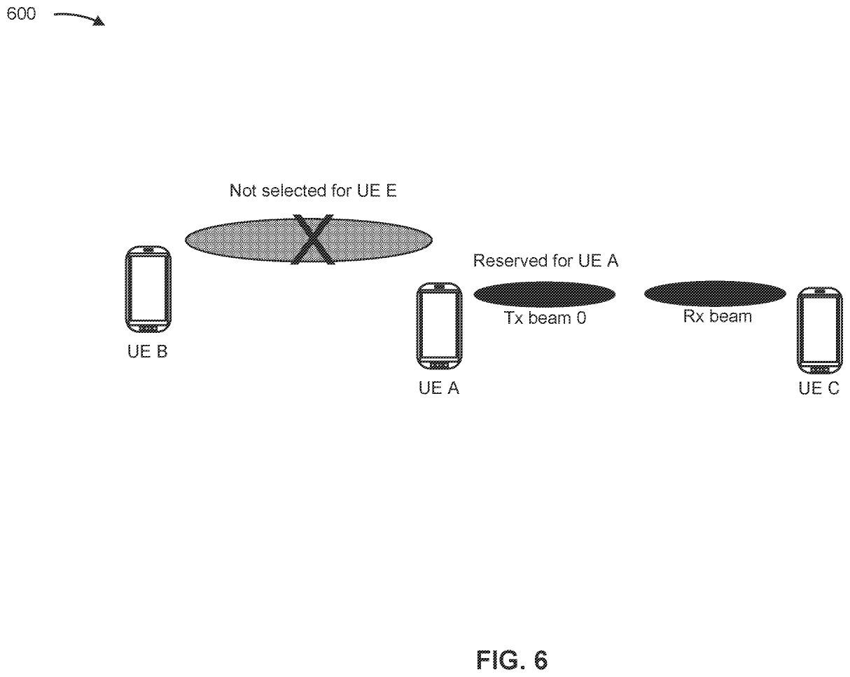

FIG. 6 is a diagram illustrating an example 600 of beam reservations, in accordance with the present disclosure.

A transmitting (Tx) UE may reserve a transmit beam in future resources, and other transmitting UEs in the same cluster may avoid selecting the transmit beam pointing in the same direction over the reserved resources. Example 600 shows that UE A may transmit a reservation on transmit beam 0. UE B may receive the reservation and avoid selecting a transmit beam that is pointing in the same direction as transmit beam 0 (using a resource selection procedure) so that UE B's transmission does not cause interference to receiving (Rx) UE C's reception from UE A.

As indicated above, FIG. 6 is provided as an example. Other examples may differ from what is described with regard to FIG. 6.

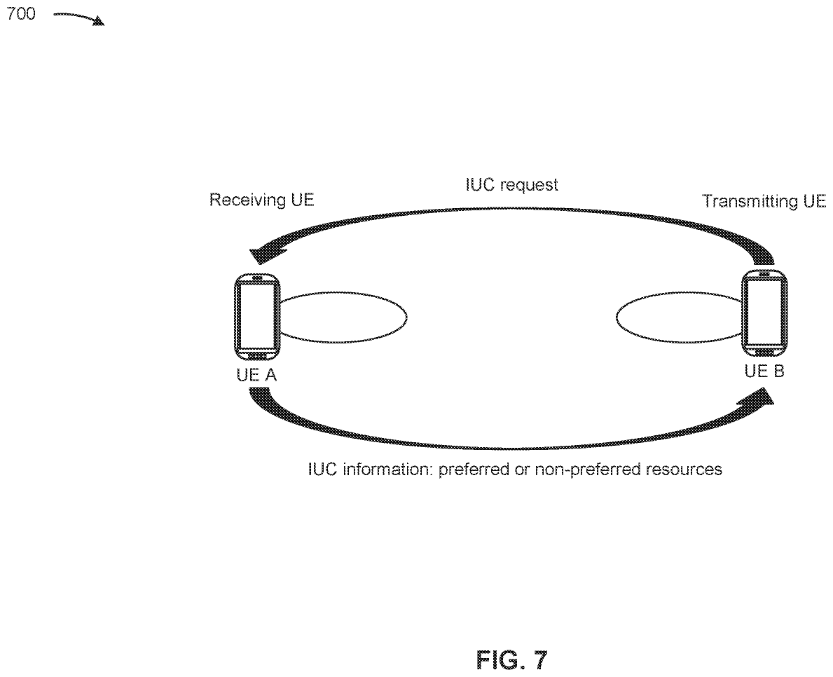

FIG. 7 is a diagram illustrating an example 700 of inter-UE coordination (IUC) information, in accordance with the present disclosure.

UEs may share IUC information with each other according to an IUC scheme. Example 700 shows an IUC scheme where UE A may receive a request for IUC information from UE B, or where a condition may trigger UE A to transmit the IUC information. UE A may transmit IUC information that indicates preferred or non-preferred resources to be used for UE B's transmissions. UE B may receive and use the IUC information for resource selection for data transmission. However, UE A may or may not be a target receiver of UE B's data transmission. Note that UE B's target receiving UE can be UE A if IUC information is triggered by request. The scheme for transmitting IUC information may be enabled or disabled by configuration. A triggering condition may also be enabled or disabled by configuration.

In an example where UE B expects preferred resources, and UE A is UE B's intended receiver, UE B expects to use resources determined as available from a receiving UE's perspective, or UE A's perspective. UE B may select a transmit resource based on channel sensing performed by UE A. When determining a preferred resource set, UE A may apply a resource selection procedure (with parameters provided in an IUC request) and exclude candidate single-slot resources belonging to slots where UE A does not expect to perform sidelink reception of a transport block due to half-duplex operation.

In an example where UE B expects non-preferred resources, if UE A is UE B's intended receiver, UE B expects information about resources in which UE A is receiving a high amount of interference from nearby transmitting UEs so that UE B can avoid those resources. If UE A is not UE B's intended receiver, UE B does not expect to create interference for UE A and can expect to obtain information about which resources to avoid in order to minimize the interference for UE A.

As indicated above, FIG. 7 is provided as an example. Other examples may differ from what is described with regard to FIG. 7.

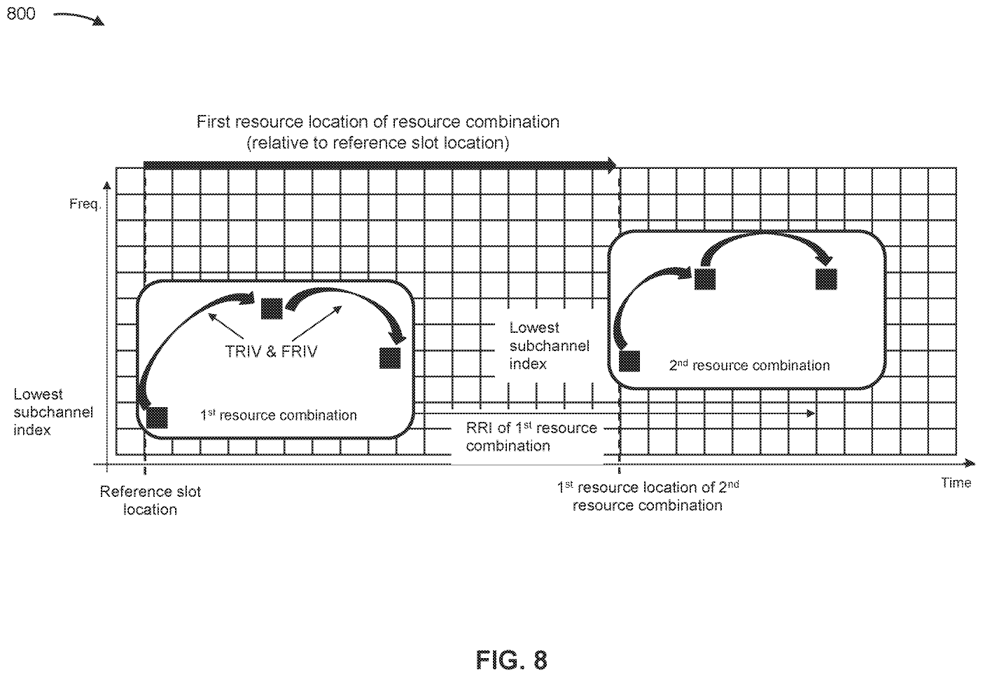

FIG. 8 is a diagram illustrating an example 800 of IUC information, in accordance with the present disclosure.

UEs may share IUC information with each other. A medium access control control element (MAC CE) or SCI 2-C may be used for the IUC information. In some examples, formats for both MAC CE and SCI 2-C may be the same (e.g., same field). In other examples, only a MAC CE may be used for indicating N>2 preferred or non-preferred resources. For N≤2, MAC CE and SCI 2-C may be used. Each preferred or non-preferred resource may be indicated using a time resource indicator value (TRIV) or time offset, a frequency resource indicator value (FRIV) or frequency offset, and/or a resource reservation interval (RRI).

Example 800 shows that resource locations in a resource slot may be associated with subchannel indices. Multiple resources may be part of a resource combination and may be associated with a TRIV and/or an FRIV. Example 800 shows a first resource combination that starts at a first resource location (relative to a reference slot location) and a second resource combination that starts at a second resource location.

An SCI 2-C or MAC CE for an IUC request may include multiple fields, such as a providing or requesting indicator, a priority, a number of subchannels (e.g., ┌log₂(N_{subChannel}^{SL})┐, where N_{subChannel}^{SL} is provided by the higher layer parameter sl-NumSubchannel), a resource reservation period Y (e.g., Y=┌log₂ N_{rsv_period} ┐ with N_{rsv_period} being the number of entries in the higher layer parameter sl-ResourceReservePeriodList, if higher layer parameter sl-MultiReserveResource is configured; Y=0 otherwise), a resource selection window location (e.g., 2(10+┌log₂(10·2^{μ})┐), where μ is 0, 1, 2, 3 for a subcarrier spacing (SCS) of 15 kilohertz (kHz), 30 kHz, 60 kHz, 120 kHz, respectively), and/or a resource set type (e.g., bit set to 1 if determineResourceSetTypeScheme 1 is set to “UE B's request”, otherwise bit is set to 0). The priority, the number of subchannels, and the resource reservation period (e.g., slots n+T₁ and n+T₂ for a resource selection window) may be UE B's intended transmit parameters. The resource selection window location may indicate a preferred or non-preferred resource set.

An SCI format 2-C may include all of the fields present in an SCI format 2-A except a cast type indicator. A resource pool level (pre-) configuration may enable one of multiple alternatives. For example, a MAC CE and a 2^{nd}-stage SCI may be used as the container of an explicit request transmission from UE B to UE A. When both SCI format 2-C and a MAC CE are used as the container of an explicit request for IUC information, the same bit field size for the request in an SCI format 2-C may be applied to the MAC CE. SCI 2-C may be optional for UE receiving. A UE may additionally use 2^{nd} SCI (for UE B). A MAC CE may be used as the container of an explicit request transmission from UE B to UE A. When a MAC CE is used as the container of an explicit request for IUC information, the same bit field size for the request in an SCI format 2-C may be applied to the MAC CE.

SCI 2-C may be used for IUC information. The IUC information may include multiple fields, such as a providing or requesting indicator, one or more resource combinations

$$( e . g . , 2 * \{ ⌈ {log}_{2} ( \frac{{N}_{subchannel}^{SL} ( {N}_{subchannel}^{SL} + 1 ) ( 2 {N}_{subchannel}^{SL} + 1 )}{6} ) ⌉ + 9 + Y \} ,$$

first resource locations, a reference slot location (e.g., 10+┌log₂ (10·2^{μ})┐, where μ is 0, 1, 2, 3 for an SCS of 15 kHz. 30 kHz, 60 kHz, 120 kHz, respectively), a resource set type, lowest subchannel indices for the first resource location of each TRIV (e.g., 2*┌log₂(N_{subchannel}^{SL})┐, where N_{subchannel}^{SL} is provided by the higher layer parameter sl-NumSubchannel, and/or an actual number of resource combinations. The field size of the indication of a resource set in an SCI format 2-C may be determined by N=2. The

$$⌈ {log}_{2} ( \frac{{N}_{subchannel}^{SL} ( {N}_{subchannel}^{SL} + 1 ) ( 2 {N}_{subchannel}^{SL} + 1 )}{6} ) ⌉$$

may be for an FRIV, the 9 may be for the TRIV, and the Y may be for the RRI. The resource reservation period may be omitted at least when the transmission of a preferred resource set is triggered by UE B's request. The resource location of each TRIV may be a slot offset with respect to a reference slot. Each lowest subchannel index for the first resource location of each TRIV may be separately indicated by IUC information. An SCI format 2-C may include all of the fields present in SCI format 2-A except for a cast type indicator. When the cast type of IUC information is unicast, an SCI format 2-C can be used in addition to a MAC CE. When both SCI format 2-C and a MAC CE are used as the container of IUC information, the maximum value of the slot offset may be 255.

As indicated above, FIG. 8 is provided as an example. Other examples may differ from what is described with regard to FIG. 8.

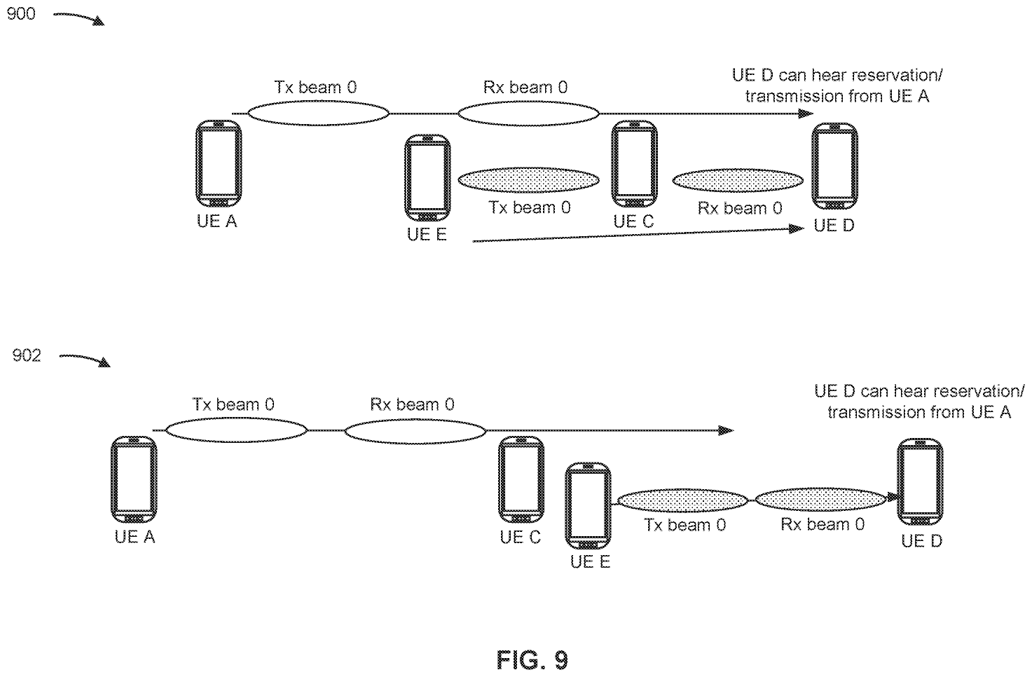

FIG. 9 is a diagram illustrating examples 900 and 902 of beam reservations, in accordance with the present disclosure.

A transmit beam reservation may work if other transmit UEs are in the same cluster or co-located. Other transmit UEs far away from the reserving UE may transmit in the same direction of the reserved transmit beam without causing interference for the reserved reception. For high frequency bands (e.g. FR2-2), the transmit and receive beams may be narrow. A reservation SCI (e.g., from UE A) may reserve the transmit beam for future resources (for the reception of UE C).

It is likely that the other links, in which the receive beam of the receive UE is paired with a reserved transmit beam (UE D's receive beam 0 is paired with transmit beam 0 from UE A/E in example 900), may potentially interfere with UE D's reserved reception. Even if the other link's transmission may not interfere with UE C's reception (in example 902), UE A's transmission could potentially interfere with UE D's reception. Such beam interference may degrade communications, which increases latency and wastes signaling resources.

As indicated above, FIG. 9 is provided as an example. Other examples may differ from what is described with regard to FIG. 9.

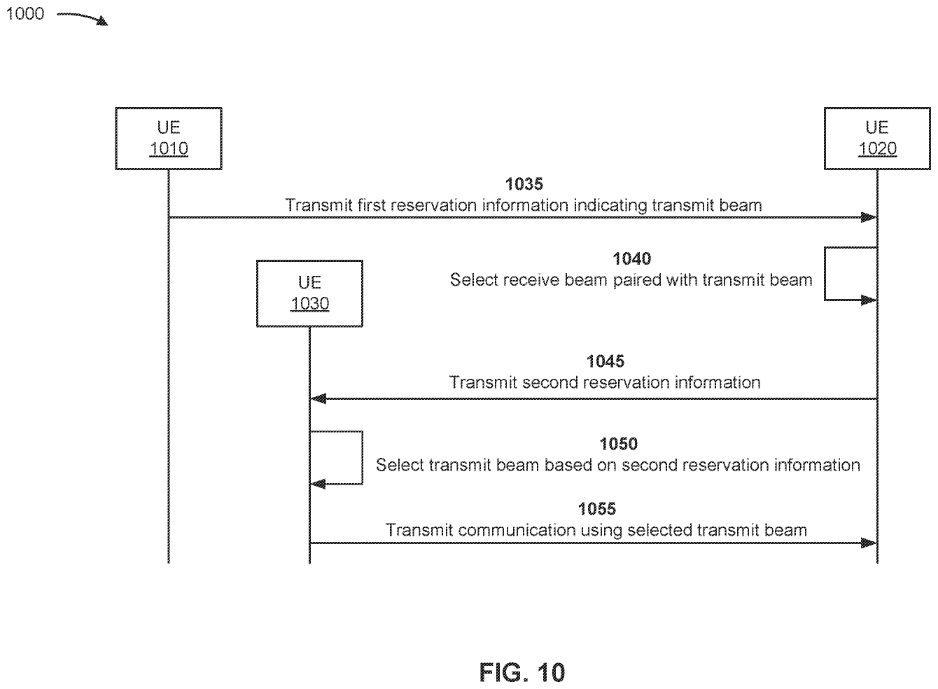

FIG. 10 is a diagram illustrating an example 1000 of beam selection, in accordance with the present disclosure. As shown in FIG. 10, a first UE 1010 (e.g., a UE 120) and a second UE 1020 (e.g., a UE 120) may communicate with one another via a sidelink. UE 1020 may also communicate with a third UE 1030 (e.g., a UE 120).

According to various aspects described herein, to avoid inter-link interference to a receiving UE (e.g., UE 1020), UE 1020 may reserve the receive beam that is paired with the reserved transmit beam signaled by another UE (e.g., UE 1010). UE 1020 may indicate, to other UEs (e.g., UE 1030), the reserved receive beam that is paired with the reserved transmit beam, preferred resources that are based at least in part on the reserved receive beam, or non-preferred resources that are based at least in part on the reserved receive beam. In this way, other low priority links may avoid transmission with a quasi-co-location (QCL) state associated with the reserved receive beam.

Example 1000 shows beam selection based on reservation information. As shown by reference number 1035, UE 1010 may transmit first reservation information (e.g., in SCI) that indicates a transmit beam that is reserved for communications from UE 1010. The first reservation information may include a beam index (e.g., absolute beam index) for the transmit beam. In some aspects, the first reservation information may also include a UE identifier (ID) of the reserving UE, which is UE 1010. The UE ID may include a common or physical UE ID such that the receiving UEs from all of the links have information about which is the reserving ID. In some aspects, the UE ID may not be a Layer 1 (L1) transmitting ID.

UE 1020 may receive and decode the first reservation information. As shown by reference number 1040, UE 1020 may select a receive beam that is paired with the transmit beam. UE 1020 may have stored information about transmit-receive beam pairs with associated beam indices. The stored information may include UE IDs associated with the beam pairs. UE 1020 may mark the receive beam as a reserved receive beam.

As shown by reference number 1045, UE 1020 may transmit second reservation information (e.g., via IUC information) to UE 1030. The second reservation information may indicate preferred resources (e.g., use other transmit beams not paired with the reserved receive beam) or non-preferred resources (e.g., do not use a transmit beam paired with the reserved receive beam).

UE 1030 may receive the second reservation information. As shown by reference number 1050, UE 1030 may select a transmit beam based at least in part on the second reservation information. For example, UE 1030 may select a transmit beam that is not paired with the reserved receive beam selected by UE 1020. As shown by reference number 1055, UE 1030 may transmit a communication using the transmit beam selected by UE 1030. In this way, UE 1020 may avoid or mitigate any interference between reception from UE 1010 and UE 1030. For example, the transmit beam used by UE 1030 does not interfere with the reserved receive beam used by UE 1020 to receive a communication from UE 1010. This improves reception of the communications. As a result of improved communications, UE 1020 reduces latency and conserves signaling resources.

As indicated above, FIG. 10 is provided as an example. Other examples may differ from what is described with respect to FIG. 10.

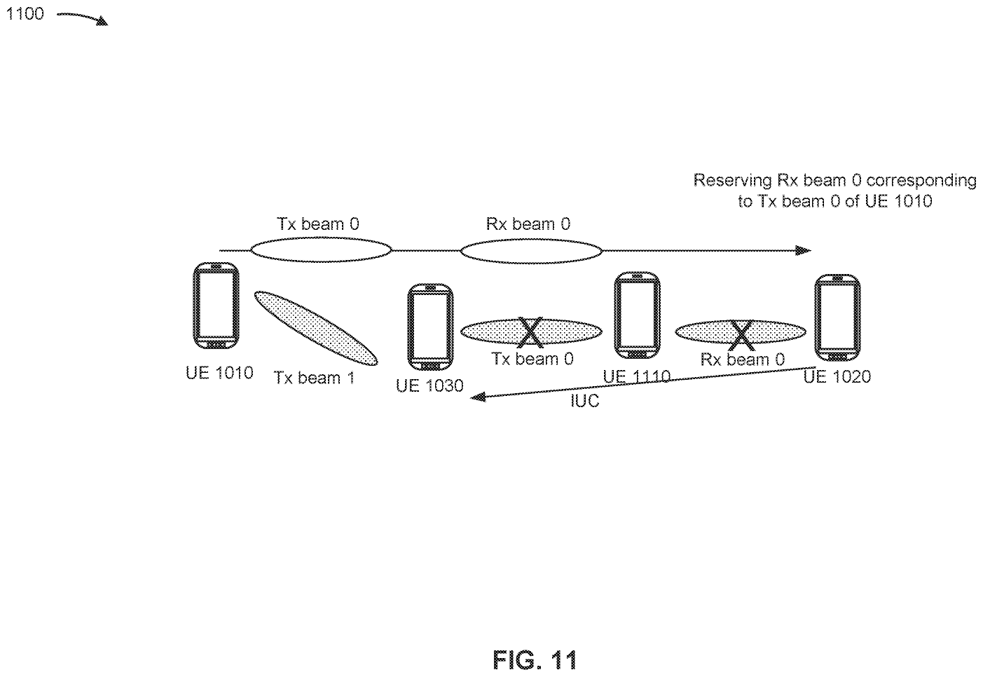

FIG. 11 is a diagram illustrating an example 1100 of beam selection, in accordance with the present disclosure.

Example 1100 shows the beams that are reserved or not selected, in connection with FIG. 10. UE 1010 may indicate a reservation for transmit (Tx) beam 0. UE 1020 may determine that receive (Rx) beam 0 is paired with Tx beam 0. UE 1020 may indicate, via IUC information, to UE 1030 to not use a transmit beam (Tx beam 0) that is paired with Rx beam 0 (see crossed out beams). While UE 1020 may be a target UE for data, there may be other UEs, such as UE 1110, that are not a target UE for data. UE 1110 may be clustered with UE 1020 or in a path of a reserved beam. In some aspects, UE 1110 may receive IUC information associated with Rx beam 0.

In some aspects, UE 1110 may not transmit an IUC request for the IUC information with a QCL state to its receiving UE, and the receiving UE may perform beam-based resource selection to provide a preferred resource set to the transmitting UE. For example, UE 1110 may not transmit an IUC request for IUC information and may not be a target for data. Another link's transmitting UE (e.g., UE 1020) may transmit an IUC request including the intended QCL for the future transmission. UE 1110 may perform beam-based resource selection to select the preferred resources (e.g., preferred receive beam, time or frequency resources). The IUC information may additionally include the preferred receive beam (or QCL states) in addition to preferred resource combinations in the form of FRIV. TRIV, and/or RRI. UE 1110 may also indicate in the IUC information the non-preferred receive beam based at least in part on the reserved receive beam (e.g., indicating the reserved receive beam in the reserved slot as a non-preferred resource). The transmitting UE, such as UE 1030, may select a different transmit beam associated with a non-reserved receive beam or select a different slot.

In some aspects, the beam-based resource selection may consider resource selection with an additional dimension of a beam and exclude the resources associated with the reserved beam/slot if a measurement of a reservation beam (e.g., signal strength, RSRP) exceeds a configured threshold (e.g., minimum RSRP). The first reservation information may include multiple reservations that are received with multiple receive beams. There may be multiple RSRP thresholds associated with different receive beams. UE 1110 may compute the RSRP for a reserved receive beam (from the reserving SCI) and compare the reserved receive beam against the beam associated RSRP threshold to determine whether to exclude the beam resource. The preferred resources may exclude the reserved receive beam in the reserved slot or avoid the reserved slot. The second reservation information may indicate one or more preferred beams or one or more non-preferred beams based at least in part on measurements of the multiple reservations. The one or more non-preferred beams May have signal strength measurements that satisfy a signal threshold. Multiple beam reservations may involve multiple RSRP thresholds. In example 1100, transmission from UE 1030 to UE 1020 may avoid the reserved slot indicated by UE 1010 to avoid causing interference to UE 1110.

As indicated above, FIG. 11 is provided as an example. Other examples may differ from what is described with regard to FIG. 11.

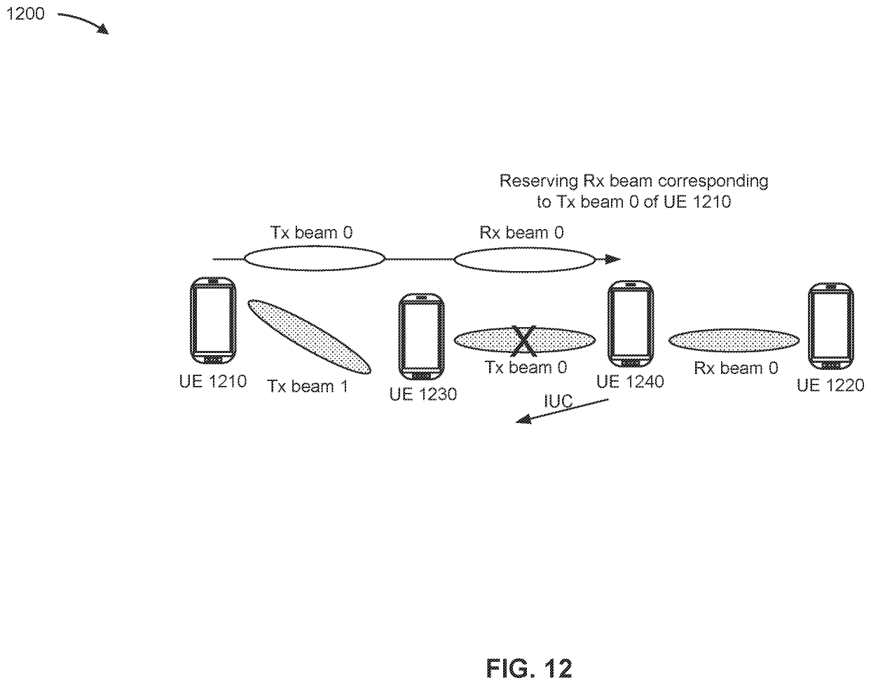

FIG. 12 is a diagram illustrating an example 1200 of indicating non-preferred resources, in accordance with the present disclosure. Example 1200 shows UE 1210, UE 1220, UE 1230, and UE 1240, which may each communicate with each other.

In some aspects, if UE 1240 (e.g., UE 120) is not the intended receiver for UE 1230's transmission, UE 1240 may still transmit a non-preferred resource set to UE 1230 to avoid a collision with the transmission from UE 1210 to UE 1240. For example, UE 1240 may indicate, in IUC information to other links' transmitting UEs (e.g., UE 1230, UE 1220), a non-preferred receive beam (reserved receive beam in its link) in the reserved slot to proactively protect its reception in reserved resources. Other transmitting UEs (e.g., UE 1230, UE 1220) may take into account the non-preferred resources from UE 1240 by avoiding scheduling a transmission in the non-preferred receive beam in the reserved slot or by selecting a different slot. In this way, collisions can be avoided, which reduces latency and conserves signaling resources.

As indicated above, FIG. 12 is provided as an example. Other examples may differ from what is described with regard to FIG. 12.

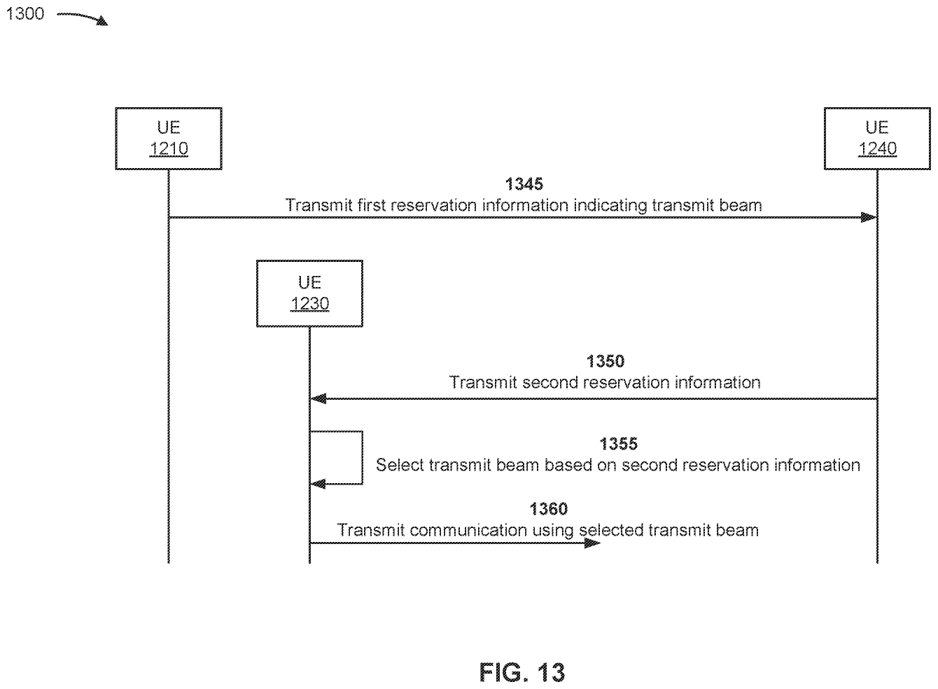

FIG. 13 is a diagram illustrating an example 1300 of indicating non-preferred resources, in accordance with the present disclosure. Example 1300 shows that UE 1240 (e.g., UE 120) may not be the intended receiver of UE 1230's transmission, as described in connection with FIG. 12, but may indicate a non-preferred resource set to UE 1230.

As shown by reference number 1345, UE 1210 may transmit first reservation information (e.g., in SCI) to UE 1240 that indicates a transmit beam that is reserved for communications from UE 1210. The first reservation information may include a beam index for the transmit beam and/or a UE ID of the reserving UE (UE 1210).

UE 1240 may receive and decode the first reservation information. UE 1240 may be the intended receiver of UE 1210 but not of UE 1230, at least not yet. UE 1240 may preemptively provide UE 1230 with second reservation information that indicates that UE 1230 is not to use a transmit beam that would conflict or interfere with the transmit beam indicated in the first reservation information from UE 1210. As shown by reference number 1350, UE 1240 may transmit the second reservation information (e.g., via IUC information) to UE 1230. The second reservation information may indicate preferred resources (e.g., transmit beams that would not interfere with the transmit beam) or non-preferred resources (e.g., do not use a transmit beam in the same direction or that is paired with the transmit beam indicated in the first reservation information).

UE 1230 may receive the second reservation information. As shown by reference number 1355, UE 1030 may select a transmit beam based at least in part on the second reservation information. For example, UE 1230 may select a transmit beam that is not in the same direction or does not interfere with the transmit beam indicated in the first reservation information. As shown by reference number 1360, UE 1230 may transmit, to UE 1240 or another nearby UE (e.g., UE 1220), a communication using the transmit beam selected by UE 1230. UE 1230 may also select another slot to transmit a communication that could interfere with UE 1240 based on the second reservation information. In this way, UE 1240 may proactively avoid or mitigate any interference caused by UE 1230. For example, the transmit beam used by UE 1230 does not interfere with the receive beam used by UE 1240 to receive a communication from UE 1210. This improves reception of the communications. As a result of improved communications, UE 1240 reduces latency and conserves signaling resources.

As indicated above, FIG. 13 is provided as an example. Other examples may differ from what is described with regard to FIG. 13.

FIG. 14 is a diagram illustrating an example process 1400 performed, for example, by a first UE, in accordance with the present disclosure. Example process 1400 is an example where the first UE (e.g., UE 120, UE 1020) performs operations associated with receive beam selection from reservation information.

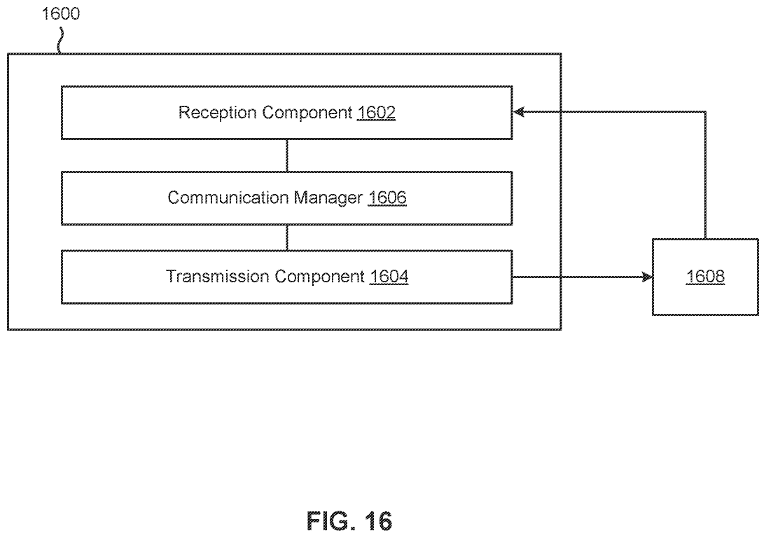

As shown in FIG. 14, in some aspects, process 1400 may include receiving, from a second UE, first reservation information that indicates a transmit beam that is reserved for communications from the second UE (block 1410). For example, the first UE (e.g., using reception component 1602 and/or communication manager 1606, depicted in FIG. 16) may receive, from a second UE, first reservation information that indicates a transmit beam that is reserved for communications from the second UE, as described above.

As further shown in FIG. 14, in some aspects, process 1400 may include selecting a receive beam that is paired with the transmit beam (block 1420). For example, the first UE (e.g., using communication manager 1606, depicted in FIG. 16) may select a receive beam that is paired with the transmit beam, as described above.

Process 1400 may include additional aspects, such as any single aspect or any combination of aspects described below and/or in connection with one or more other processes described elsewhere herein.

In a first aspect, the first UE is a target UE for data from the second UE, and the communications are from the second UE to the first UE.

In a second aspect, alone or in combination with the first aspect, the first UE is not a target UE for data from the second UE.

In a third aspect, alone or in combination with one or more of the first and second aspects, the first reservation information includes a beam index for the transmit beam.

In a fourth aspect, alone or in combination with one or more of the first through third aspects, process 1400 includes storing pairs of transmit beam and receive beam indices.

In a fifth aspect, alone or in combination with one or more of the first through fourth aspects, process 1400 includes transmitting, to a third UE, second reservation information that is based at least in part on the receive beam.

In a sixth aspect, alone or in combination with one or more of the first through fifth aspects, the second reservation information indicates that the third UE is to use a transmit beam that is not paired with the receive beam.

In a seventh aspect, alone or in combination with one or more of the first through sixth aspects, the second reservation information indicates a preferred transmit beam that the third UE is to use as a transmit beam, and the preferred transmit beam is not paired with the receive beam.

In an eighth aspect, alone or in combination with one or more of the first through seventh aspects, the first reservation information includes multiple reservations that are received with multiple receive beams, and the second reservation information indicates one or more preferred beams or one or more non-preferred beams based at least in part on measurements of the multiple reservations.

In a ninth aspect, alone or in combination with one or more of the first through eighth aspects, the measurements include signal strength measurements of the receive beams used to receive the multiple reservations.

In a tenth aspect, alone or in combination with one or more of the first through ninth aspects, the one or more non-preferred beams have signal strength measurements that satisfy a signal threshold.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a first UE, in accordance with the present disclosure. Example process 1500 is an example where the first UE (e.g., UE 120, UE 1240) performs operations associated with providing reservation information.

As shown in FIG. 15, in some aspects, process 1500 may include receiving, from a second UE, first reservation information that indicates a transmit beam that is reserved for communications from the second UE (block 1510). For example, the first UE (e.g., using reception component 1602 and/or communication manager 1606, depicted in FIG. 16) may receive, from a second UE, first reservation information that indicates a transmit beam that is reserved for communications from the second UE, as described above.

As further shown in FIG. 15, in some aspects, process 1500 may include transmitting, to a third UE, second reservation information that indicates that the third UE is to not use a beam resource that is associated with a receive beam that is paired with the transmit beam (block 1520). For example, the first UE (e.g., using transmission component 1604 and/or communication manager 1606, depicted in FIG. 16) may transmit, to a third UE, second reservation information that indicates that the third UE is to not use a beam resource that is associated with a receive beam that is paired with the transmit beam, as described above.

Process 1500 may include additional aspects, such as any single aspect or any combination of aspects described below and/or in connection with one or more other processes described elsewhere herein.

In a first aspect, the first reservation information includes a beam index for the transmit beam.

In a second aspect, alone or in combination with the first aspect, the second reservation information indicates a preferred transmit beam that the third UE is to use as a transmit beam.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a first UE (e.g., UE 120, UE 1020, UE 1240), or a UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 1-13. Additionally, or alternatively, the apparatus 1600 may be configured to perform one or more processes described herein, such as process 1400 of FIG. 14, process 1500 of FIG. 15, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

In some aspects, the reception component 1602 may receive, from a second UE, first reservation information that indicates a transmit beam that is reserved for communications from the second UE. The communication manager 1606 may select a receive beam that is paired with the transmit beam.

The communication manager 1606 may store pairs of transmit beam and receive beam indices. The transmission component 1604 may transmit, to a third UE, second reservation information that is based at least in part on the receive beam.

In some aspects, the reception component 1602 may receive, from a second UE, first reservation information that indicates a transmit beam that is reserved for communications from the second UE. The transmission component 1604 may transmit, to a third UE, second reservation information that indicates that the third UE is to not use a beam resource that is associated with a receive beam that is paired with the transmit beam.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a first user equipment (UE), comprising: receiving, from a second UE, first reservation information that indicates a transmit beam that is reserved for communications from the second UE; and selecting a receive beam that is paired with the transmit beam.

Aspect 2: The method of Aspect 1, wherein the first UE is a target UE for data from the second UE, and wherein the communications are from the second UE to the first UE.

Aspect 3: The method of any of Aspects 1-2, wherein the first UE is not a target UE for data from the second UE.

Aspect 4: The method of any of Aspects 1-3, wherein the first reservation information includes a beam index for the transmit beam.

Aspect 5: The method of any of Aspects 1-4, further comprising storing pairs of transmit beam and receive beam indices.

Aspect 6: The method of any of Aspects 1-5, further comprising transmitting, to a third UE, second reservation information that is based at least in part on the receive beam.

Aspect 7: The method of Aspect 6, wherein the second reservation information indicates that the third UE is to use a transmit beam that is not paired with the receive beam.

Aspect 8: The method of Aspect 6, wherein the second reservation information indicates a preferred transmit beam that the third UE is to use as a transmit beam, and wherein the preferred transmit beam is not paired with the receive beam.

Aspect 9: The method of Aspect 6, wherein the first reservation information includes multiple reservations that are received with multiple receive beams, and wherein the second reservation information indicates one or more preferred beams or one or more non-preferred beams based at least in part on measurements of the multiple reservations.

Aspect 10: The method of Aspect 9, wherein the measurements include signal strength measurements of the receive beams used to receive the multiple reservations.

Aspect 11: The method of Aspect 9, wherein the one or more non-preferred beams have signal strength measurements that satisfy a signal threshold.

Aspect 12: A method of wireless communication performed by a first user equipment (UE), comprising: receiving, from a second UE, first reservation information that indicates a transmit beam that is reserved for communications from the second UE; and transmitting, to a third UE, second reservation information that indicates that the third UE is to not use a beam resource that is associated with a receive beam that is paired with the transmit beam.

Aspect 13: The method of Aspect 12, wherein the first reservation information includes a beam index for the transmit beam.

Aspect 14: The method of any of Aspects 12-13, wherein the second reservation information indicates a preferred transmit beam that the third UE is to use as a transmit beam.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
one or more memories; and
one or more processors coupled to the one or more memories, the one or more processors individually or collectively configured to cause the first UE to:
receive, from a second UE, first reservation information that indicates a transmit beam that is reserved for communications from the second UE; and
select a receive beam that is paired with the transmit beam.

2. The first UE of claim 1, wherein the first UE is a target UE for data from the second UE, and wherein the communications are from the second UE to the first UE.

3. The first UE of claim 1, wherein the first UE is not a target UE for data from the second UE.

4. The first UE of claim 1, wherein the first reservation information includes a beam index for the transmit beam.

5. The first UE of claim 1, wherein the one or more processors are individually or collectively configured to store pairs of transmit beam and receive beam indices.

6. The first UE of claim 1, wherein the one or more processors are individually or collectively configured to transmit, to a third UE, second reservation information that is based at least in part on the receive beam.

7. The first UE of claim 6, wherein the second reservation information indicates that the third UE is to use a transmit beam that is not paired with the receive beam.

8. The first UE of claim 6, wherein the second reservation information indicates a preferred transmit beam that the third UE is to use as a transmit beam, and wherein the preferred transmit beam is not paired with the receive beam.

9. The first UE of claim 6, wherein the first reservation information includes multiple reservations that are received with multiple receive beams, and wherein the second reservation information indicates one or more preferred beams or one or more non-preferred beams based at least in part on measurements of the multiple reservations.

10. The first UE of claim 9, wherein the measurements include signal strength measurements of the receive beams used to receive the multiple reservations.

11. The first UE of claim 9, wherein the one or more non-preferred beams have signal strength measurements that satisfy a signal threshold.

12. A first user equipment (UE) for wireless communication, comprising:
one or more memories; and
one or more processors coupled to the one or more memories, the one or more processors individually or collectively configured to cause the first UE to:
receive, from a second UE, first reservation information that indicates a transmit beam that is reserved for communications from the second UE; and
transmit, to a third UE, second reservation information that indicates that the third UE is to not use a beam resource that is associated with a receive beam that is paired with the transmit beam.

13. The first UE of claim 12, wherein the first reservation information includes a beam index for the transmit beam.

14. The first UE of claim 12, wherein the second reservation information indicates a preferred transmit beam that the third UE is to use as a transmit beam.

15. A method of wireless communication performed by a first user equipment (UE), comprising:
receiving, from a second UE, first reservation information that indicates a transmit beam that is reserved for communications from the second UE; and
selecting a receive beam that is paired with the transmit beam.

16. The method of claim 15, wherein the first UE is a target UE for data from the second UE, and wherein the communications are from the second UE to the first UE.

17. The method of claim 15, wherein the first UE is not a target UE for data from the second UE.

18. The method of claim 15, wherein the first reservation information includes a beam index for the transmit beam.

19. The method of claim 15, further comprising storing pairs of transmit beam and receive beam indices.

20. The method of claim 15, further comprising transmitting, to a third UE, second reservation information that is based at least in part on the receive beam.

21. The method of claim 20, wherein the second reservation information indicates that the third UE is to use a transmit beam that is not paired with the receive beam.

22. The method of claim 20, wherein the second reservation information indicates a preferred transmit beam that the third UE is to use as a transmit beam, and wherein the preferred transmit beam is not paired with the receive beam.

23. The method of claim 20, wherein the first reservation information includes multiple reservations that are received with multiple receive beams, and wherein the second reservation information indicates one or more preferred beams or one or more non-preferred beams based at least in part on measurements of the multiple reservations.

24. The method of claim 23, wherein the measurements include signal strength measurements of the receive beams used to receive the multiple reservations.

25. The method of claim 23, wherein the one or more non-preferred beams have signal strength measurements that satisfy a signal threshold.

26. A method of wireless communication performed by a first user equipment (UE), comprising:
receiving, from a second UE, first reservation information that indicates a transmit beam that is reserved for communications from the second UE; and
transmitting, to a third UE, second reservation information that indicates that the third UE is to not use a beam resource that is associated with a receive beam that is paired with the transmit beam.

27. The method of claim 26, wherein the first reservation information includes a beam index for the transmit beam.

28. The method of claim 26, wherein the second reservation information indicates a preferred transmit beam that the third UE is to use as a transmit beam.
